(19) United States
(12) Patent Application Publication
(10) Pub. No.: US 2024/0170790 A1
(43) Pub. Date: May 23, 2024

(54) BATTERY MODULE AND BATTERY PACK INCLUDING THE SAME

(71) Applicant: LG Energy Solution, Ltd., Seoul (KR)

(72) Inventors: Sung Won Seo, Daejeon (KR); Hyeonki Yun, Daejeon (KR); Eunah Ju, Daejeon (KR); Uwe Harasztosi, Neckarsulm (DE); Thomas Fassl, Eppingen (DE)

(21) Appl. No.: 18/284,489

(22) PCT Filed: Nov. 18, 2022
(86) PCT No.: PCT/KR2022/018337

§ 371 Date: Sep. 27, 2023

(30) Foreign Application Priority Data
Nov. 19, 2021 (KR) 10-2021-0159973

(51) Int. Cl. H01M 50/256; H01M 50/211; H01M 50/264; H01M 50/507

(52) U.S. Cl. CPC H01M 50/256; H01M 50/211; H01M 50/264; H01M 50/507

(57) ABSTRACT

A battery module including a stack of a plurality of battery cells; and a first side plate and a second side plate located at opposite side surfaces of the battery cell stack. At least one lifting hole is formed in each of the first side plate and the second side plate. The lifting hole has a shape in which an insertion hole and a fastening hole overlap, and an opening area of the insertion hole is larger than an opening area of the fastening hole.

### CROSS-REFERENCE TO RELATED APPLICATIONS

This application is a US national stage of international Application No. PCT/KR2022/018337 Nov. 18, 2022 and claims the benefit of Korean Patent Application No. 10-2021-0159973 filed on Nov. 19, 2021, the entire contents of which are incorporated herein by reference.

### TECHNICAL FIELD

The present disclosure relates to a battery module and a battery pack including the same, and more particularly, to a battery module including a plurality of battery cells, and a battery pack including the same.

### BACKGROUND

In modern society, as portable devices such as a mobile phone, a notebook computer, a camcorder and a digital camera has been daily used, the development of technologies in the fields related to mobile devices as described above has been activated. In addition, chargeable/dischargeable secondary batteries are used as a power source for an electric vehicle (EV), a hybrid electric vehicle (HEV), a plug-in hybrid electric vehicle (P-HEV) and the like, in an attempt to solve air pollution and the like caused by existing gasoline vehicles using fossil fuel. Therefore, the demand for development of the secondary battery is growing.

Currently commercialized secondary batteries include a nickel cadmium battery, a nickel hydrogen battery, a nickel zinc battery, and a lithium secondary battery. Among them, the lithium secondary battery has come into the spotlight because it has advantages, for example, it hardly exhibits memory effects compared to nickel-based secondary batteries and thus can be freely charged and discharged, and has very low self-discharge rate and high energy density.

Such a lithium secondary battery mainly uses a lithium-based oxide and a carbonaceous material as a positive electrode active material and a negative electrode active material, respectively. The lithium secondary battery comprises an electrode assembly in which a positive electrode plate and a negative electrode plate, each being coated with the positive electrode active material and the negative electrode active material, respectively, are disposed with a separator being interposed between them, and a battery case which seals and houses the electrode assembly together with an electrolyte solution.

Generally, the lithium secondary battery may be classified into a can-type secondary battery in which the electrode assembly is mounted in a metal can, and a pouch-type secondary battery in which the electrode assembly is mounted in a pouch of an aluminum laminate sheet, depending on the shape of the exterior material.

Two to three battery cells are disposed in a secondary battery used for small-sized devices, but a battery module in which a large number of battery cells are electrically connected is used in a secondary battery used for a medium- and large-sized devices such as automobiles. In such a battery module, a large number of battery cells are connected to each other in series or parallel to form a cell assembly, thereby improving capacity and output. Further, one or more battery modules can be mounted together with various control and protection systems such as a BDU (Battery Disconnect Unit), a BMS (battery management system) and a cooling system to form a battery pack.

When configuring a battery pack, it is common to configure a battery module first and then configure a battery pack by using a battery module and adding other components. A conventional battery pack is manufactured by arranging battery modules in a housing structure such as a pack tray, and such a battery pack is mounted on a vehicle or the like.

FIG. 1 is a perspective view of a conventional battery module 10.

Referring to FIG. 1, a conventional battery module 10 has a shape in which a plurality of battery cells are housed and sealed in a housing 20. A suction device 11 can be used in the process of transferring the battery module 10. Specifically, a plurality of suction devices 11 may be attached to the upper surface of the housing 20 of the battery module 10 and operated to transfer the battery module 10. The suction device 11 as described above is one example of a method of transferring the battery module 10, but it is common to use such a housing 20 during the transferring process for the conventional battery module 10.

In a battery pack having conventional battery modules, there is a problem that the energy density of the entire battery pack decreases and the weight of the battery pack increases because of the weight and volume of the housing structure itself, such as the housing of the battery module and the pack tray.

There is a need to develop a battery module that can further increase the energy density and reduce the overall weight through weight reduction, and a battery pack including the same.

### SUMMARY

It is an objective of the present disclosure to provide a battery module capable of increasing an energy density and reducing a weight, and a battery pack including the same.

However, the technical problem to be solved by the embodiments of the present disclosure is not limited to the above-described problems, and can be variously expanded within the scope of the technical idea included in the present disclosure.

A battery module according to one embodiment of the present disclosure comprises a battery cell stack in which a plurality of battery cells are stacked; and a first side plate and a second side plate each located at both side surfaces of the battery cell stack. At least one lifting hole is formed in each of the first side plate and the second side plate. The lifting hole has a shape in which an insertion hole and a fastening hole overlap, and an opening area of the insertion hole is larger than an opening area of the fastening hole.

The fastening hole may be located higher than the insertion hole, and the opening area of the insertion hole and the opening area of the fastening hole may be connected to each other.

The insertion hole and the fastening hole each may be in the shape of an open circular or polygon.

The battery module may further comprise a first end plate and a second end plate each located on a first side and a second side of the battery cell stack; a first busbar frame located between the battery cell stack and the first end plate; and a second busbar frame located between the battery cell stack and the second end plate. The lifting hole may be formed in a portion corresponding to the first busbar frame or a portion corresponding to the second busbar frame in the first side plate or the second side plate.

A chamber portion may be formed in each of a first busbar frame portion corresponding to one of the lifting holes and a second busbar frame portion corresponding to the other of the lifting holes.

The chamber portion may have a shape that is open at one side, and the lifting hole may be located at the open side of the chamber portion.

The battery module may further comprise busbars mounted on the first busbar frame and the second busbar frame, wherein electrode leads of the battery cells pass through lead slits formed in the first busbar frame or the second busbar frame, and then may be bent and connected to the busbar.

A transfer member may be inserted into the insertion hole, and the transfer member may lift the battery module through the fastening hole.

The battery module may further comprise connecting members that are located at each of the upper and lower sides of the battery cell stack, and connect the first side plate and the second side plate.

The connecting members may be band members that are connected to the first side plate and the second side plate.

The band member may comprise a band body disposed on the upper side or the lower side of the battery cell stack, and band clips bent from the band body and fixed to each of the first side plate and the second side plate.

The connecting members may comprise long bolt members that are fastened with the first side plate and the second side plate.

The connecting members are disposed apart from each other on the upper side or the lower side of the battery cell stack.

A battery pack according to one embodiment of the present disclosure comprises the above-mentioned battery module; and a pack tray that houses the battery module. A first side plate and a second side plate of the battery module may be fixed to a pack tray.

Each of the first side plate and the second side plate may comprise a support portion that is disposed perpendicular to the bottom portion of the pack tray to support the outermost battery cell of the battery cell stack, and a fixing portion that protrudes in a direction perpendicular to one surface of the support portion, and the fixing portion may be fixed to the pack tray.

The battery pack may further comprise a mounting beam that is disposed on the upper surface of the bottom portion of the pack tray, wherein the fixing portion may be fixed to the mounting beam.

The fixing portion may be located higher than the height of the mounting beam in the height direction.

According to embodiments of the present disclosure, it is possible to provide a battery module that has a simplified structure, has improved energy density per weight and enables weight reduction, and a battery pack including the same.

In addition, module handling using side plates can be applied to conform to the simplification of the module structure, thereby improving manufacturing process efficiency and space utilization.

The effects of the present disclosure are not limited to the effects mentioned above and additional other effects not mentioned above will be clearly understood from the description of the appended claims by those skilled in the art.

### BRIEF DESCRIPTION OF THE DRAWINGS

FIG. 1 is a perspective view of a conventional battery module;

FIG. 2 is a perspective view of a battery module according to one embodiment of the present disclosure;

FIG. 3 is an exploded perspective view of the battery module of FIG. 2;

FIG. 4 is a side view of a battery cell included in the battery module of FIG. 3;

FIG. 5 is an enlarged partial perspective view of section A of FIG. 2;

FIGS. 6A and 6B are schematic illustrations of a lifting hole according to various embodiments of the present disclosure;

FIG. 7 is an enlarged partial perspective view of section B of FIG. 3;

FIG. 8 is a perspective view of a transfer member according to one embodiment of the present disclosure;

FIG. 9 is a perspective view of the battery module of FIG. 2 and the transfer member of FIG. 8 together;

FIG. 10 is an enlarged partial perspective view of section C of FIG. 9;

FIG. 11 is a perspective view of a process of transferring the battery module according to the present embodiment using a transfer member.

FIG. 12 is a perspective view of a side plate and a connecting member according to another embodiment of the present disclosure;

FIG. 13 is a perspective view of a first side plate according to one embodiment of the present disclosure;

FIG. 14 is a perspective view of a battery pack according to one embodiment of the present disclosure; and

FIG. 15 is a partial perspective view of a method of fixing a battery module to a pack tray in the battery pack according to the present embodiment.

### DETAILED DESCRIPTION

Hereinafter, various embodiments of the present disclosure will be described in detail with reference to the accompanying drawings so that those skilled in the art can easily carry out the embodiments. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

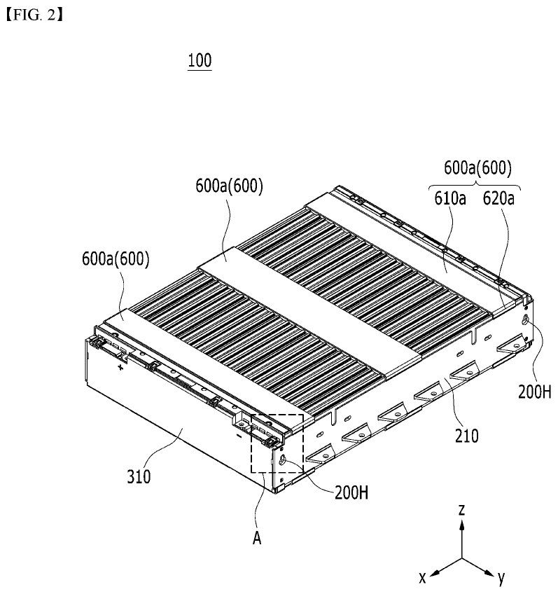

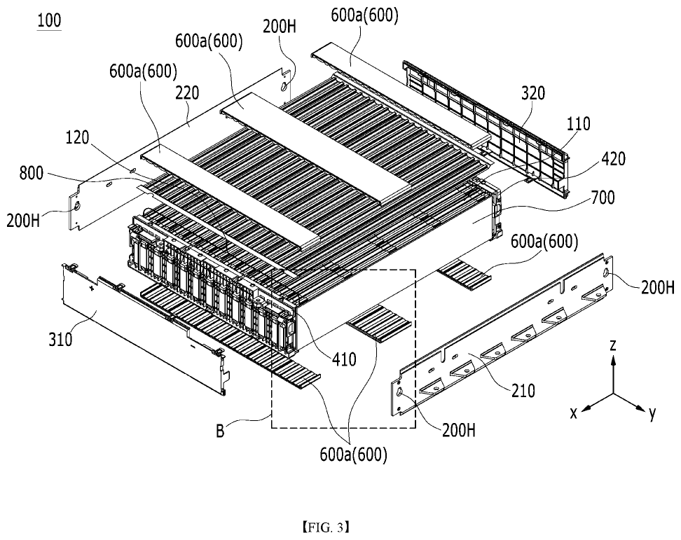

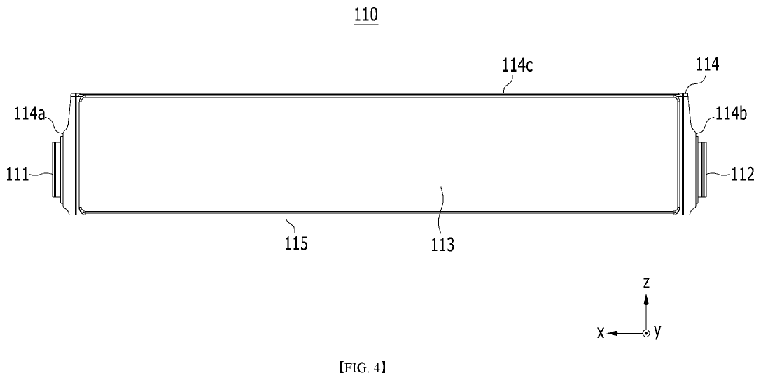

FIG. 2 is a perspective view of a battery module according to one embodiment of the present disclosure. FIG. 3 is an exploded perspective view of the battery module of FIG. 2. FIG. 4 is a side view of a battery cell included in the battery module of FIG. 3.

Referring to FIGS. 2 to 4, a battery module 100 according to one embodiment of the present disclosure comprises a battery cell stack 120 in which a plurality of battery cells 110 are stacked, and a first side plate 210 and a second side plate 220 located at opposite side surfaces of the battery cell stack 120.

The battery cell 110 may be a pouch-type battery cell. Such a pouch-type battery cell may be formed by housing the electrode assembly in a pouch case of a laminated sheet containing a resin layer and a metal layer, and then joining the outer peripheral portion of the pouch case. Such a battery cell 110 may be formed in a rectangular sheet-like structure. Specifically, the battery cell 110 according to the present embodiment has a structure in which two electrode leads 111 and 112 face each other and protrude from one end 114a and the opposite end 114b of the cell main body 113, respectively. The battery cell 110 can be produced by joining both ends 114a and 114b of a cell case 114 and one side portion 114c connecting them in a state in which an electrode assembly (not shown) is housed in a cell case 114. In other words, the battery cell 110 according to the present embodiment has a total of three sealing portions, the sealing portions have a structure that is sealed by a method such as fusion, and the remaining other side portion may be composed of a connecting portion 115.

However, the battery cell 110 described above is an illustrative structure, and it goes without saying that a unidirectional battery cell in which the two electrode leads protrude in the same direction is available.

A plurality of battery cells 110 may be formed, and the plurality of battery cells 110 may be stacked to be electrically connected to each other, thereby forming a battery cell stack 120. Particularly, as shown in FIG. 3, a plurality of battery cells 110 may be stacked along the direction parallel to the y-axis. The battery case 114 is generally constituted in a laminated structure of resin layer/metal thin film layer/resin layer. For example, when the surface of the battery case is formed of an O (oriented)-nylon layer, it tends to slide easily due to external impact when stacking a plurality of battery cells to form a medium- or large-sized battery module. Therefore, an adhesive member such as a cohesive-type adhesive such as a double-sided tape or a chemical adhesive bonded by chemical reaction during adhesion can be attached to the surface of the battery case to form a battery cell stack 120 to prevent this problem and maintain a stable stacked structure of battery cells.

The first side plate 210 and the second side plate 220 are located at both side surfaces of the battery cell stack 120 to support the battery cell stack 120. More specifically, they may be located at opposite side surfaces in a direction in which a plurality of battery cells 110 are stacked, that is, in a direction parallel to the y-axis in FIG. 3. At least one lifting hole 200H is formed in each of the first side plate 210 and the second side plate 220. The lifting hole 200H will be described later.

Meanwhile, the battery module 100 according to the present embodiment may include connecting members 600 that are located at each of the upper side and the lower side of the battery cell stack 120, and connect the first side plate 210 and the second side plate 220.

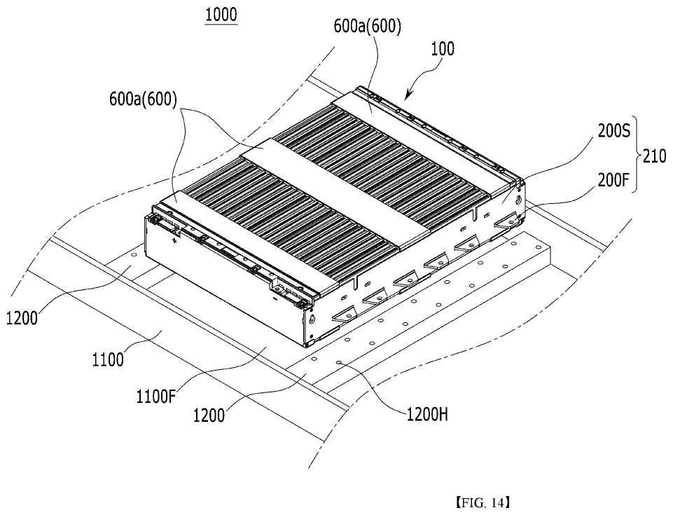

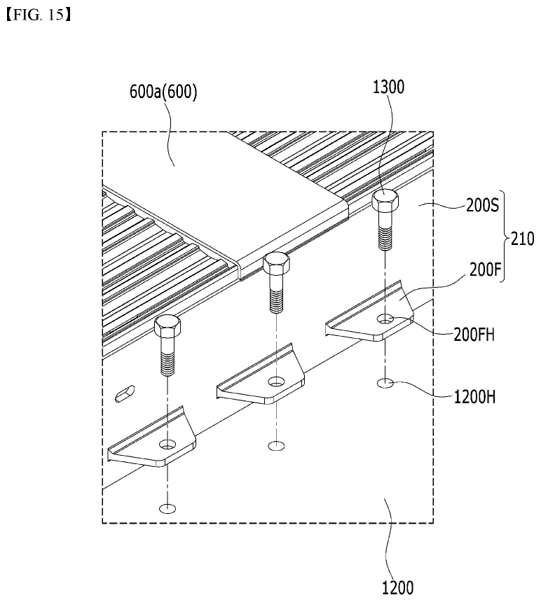

Unlike the conventional battery module 10, the battery module 100 according to the present embodiment is not in the shape in which the battery cell stack 120 is housed and sealed in a housing, but has a structure in which the first side plate 210 and the second side plate 220 are disposed on both side surfaces of the battery cell stack 120, and the first side plate 210 and the second side plate 220 are fixed via the connecting members 600. That is, the battery module 100 according to the present embodiment has a simplified housing structure as compared to a conventional battery module, and can be mounted directly to a battery pack without a sealed housing. The shape of being mounted to the battery pack will be described later along with FIGS. 14 and 15.

Ultimately, in the present embodiment, the housing structure is omitted, thereby increasing space utilization in a battery pack unit, improving overall energy density, and enabling weight reduction, which will be described later. Further, as shown in FIG. 3, the connecting members 600 may be disposed apart from each other on the upper side or the lower side of the battery cell stack 120. A thermally conductive member and a heat sink can be disposed in the space between the spaced apart connecting members 600. This leads to an advantage that the cooling member in the module unit and the cooling member in the pack unit can be integrated to provide only one cooling member. That is, it is possible to integrate and shorten the cooling path of the battery module 100 inside the battery pack, thereby realizing the effect of weight reduction and cost reduction.

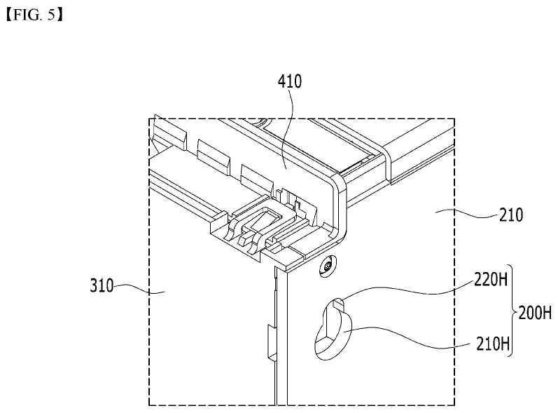

Next, the lifting hole according to the present embodiment will be described in detail with reference to FIG. 5 and the like.

FIG. 5 is an enlarged partial perspective view of section A of FIG. 2.

Referring to FIGS. 2, 3 and 5 together, at least one lifting hole 200H is formed in each of the first side plate 210 and the second side plate 220 according to the present embodiment. The number and position of the lifting holes 200H are not particularly limited, but as an example, as shown in FIG. 3, two lifting holes 200H may be formed at portions adjacent to each of both ends of the first side plate 210, and the other two lifting holes 200H may be formed at portions adjacent to each of both ends of the second side plate 220.

The lifting hole 200H is a through hole formed in the first side plate 210 or the second side plate 220, and has a shape in which an insertion hole 210H and a fastening hole 220H overlap. In other words, as illustrated, this is a shape in which two holes overlap each other, which may be a shape in which the opening area of the insertion hole 210H and the opening area of the fastening hole 220H may be connected to each other. At this time, the opening area of the insertion hole 210H is larger than the opening area of the fastening hole 220H. Also, the fastening hole 220H may be located higher than the insertion hole 210H.

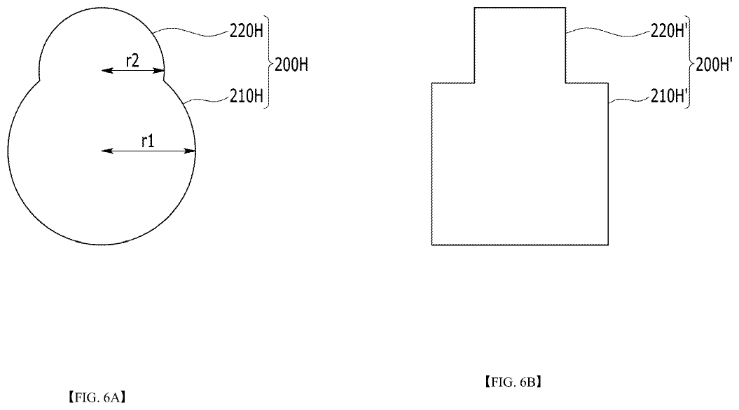

FIG. 6 schematically shows a lifting hole according to various embodiments of the present disclosure.

Referring to FIGS. 6A and 6B, if the opening areas of the insertion holes 210H and 210H′ in the lifting holes 200H and 200H′ according to the present embodiments, respectively, are larger than the opening areas of the fastening holes 220H and 220H′, the shapes of the insertion holes 210H and 210H′ and the fastening holes 220H and 220H′ are not particularly limited, but the insertion holes 210H and 210H′ and the shape of the fastening holes 220H and 220H′ may be an open circle or an open polygon.

FIG. 6A shows an embodiment in which the insertion hole 210H and the fastening hole 220H each have an open circular shape. The insertion hole 210H can have a larger opening area because the radius r1 of the insertion hole 210H is formed larger than the radius r2 of the fastening hole 220H.

FIG. 6B shows an embodiment in which the insertion hole 210H′ and the fastening hole 220H′ each have an open rectangular shape as an example of an open polygonal shape. Similarly, the insertion hole 210H′ may have a larger opening area.

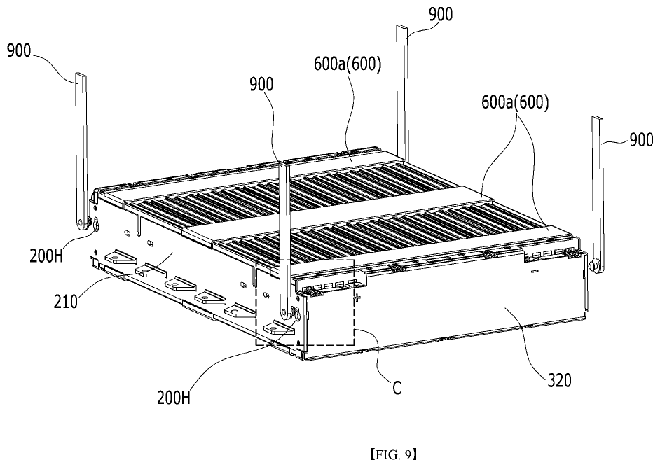

The function of the lifting hole 200H will be described later in detail with reference to FIGS. 9 to 11.

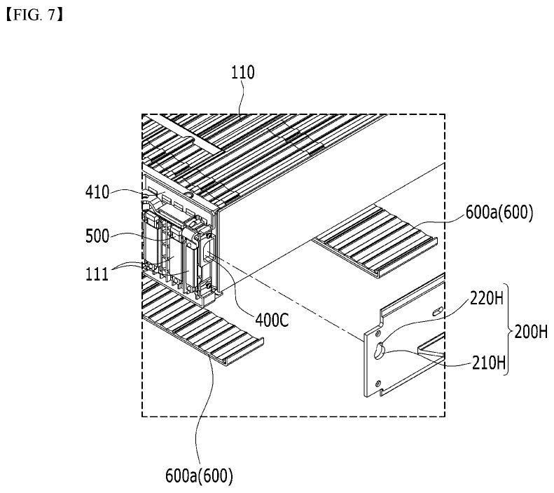

FIG. 7 is an enlarged partial perspective view of section B of FIG. 3.

Referring to FIGS. 3, 4, 5 and 7 together, the battery module 100 according to the present embodiment may further comprise a first end plate 310 and a second end plate 320 located on one side and the other side of the battery cell stack 120, respectively; a first busbar frame 410 located between the battery cell stack 120 and the first end plate 310; and a second busbar frame 420 located between the battery cell stack 120 and the second end plate 320.

More specifically, the first busbar frame 410 and the first end plate 310 may be sequentially located in one direction (x-axis direction) in which any one electrode lead 111 (see FIG. 4) of the battery cells 110 protrudes, and the second busbar frame 420 and the second end plate 320 may be sequentially located in an opposite direction (−x-axis direction) in which the other electrode lead 112 (see FIG. 4) of the battery cell 110 protrudes.

The first busbar frame 410 and the second busbar frame 420 may be disposed to cover each of the front surface and the rear surface of the battery cell stack corresponding to the directions (x-axis direction and −x-axis direction) in which the electrode leads 111 and 112 protrude.

The first end plate 310 and the second end plate 320 may be respectively disposed to cover one surface of the first busbar frame 410 and one surface of the second busbar frame 420. The first end plate 310 and the second end plate 320 may be plastic insulating covers having electrical insulation, and can protect the busbars 500 of electrode leads 111 and 112 located on the first busbar frame 410 and the second busbar frame 420, and other electrical components from the outside, and at the same time, cut off occurrence possibility of short-circuit with the outside. Meanwhile, a coupling method between the first and second end plates 310 and 320 and the first and second side plates 210 and 220 is not particularly limited, and a mechanical coupling method or a bolt coupling can be applied as an example.

In another embodiment of the present disclosure, the first end plate 310 and the second end plate 320 may include a metal material such as aluminum and thus have high stiffness. However, in this case, it is preferable to add separate insulation covers between the first end plate 310 and the first bus bar frame 410 and between the second end plate 320 and the second busbar frame 420.

As shown in FIG. 7, the battery module 100 according to the present embodiment may further include busbars 500 mounted on the first busbar frame 410 and the second busbar frame 420. Illustration of the second busbar frame 420 and the busbar 500 mounted thereto are omitted, but they may have a structure similar to that of the first busbar frame 410 shown in FIG. 7.

The electrode leads 111 and 112 of the battery cell 110 may pass through lead slits formed in the first busbar frame 410 or the second busbar frame 420 and then be bent and connected to the respective busbar 500. More specifically, any one electrode lead 111 may pass through the lead slit of the first busbar frame 410, and be connected to the busbar 500 mounted to the first busbar frame 410, and the other electrode lead 112 may pass through the lead slit of the second busbar frame 420, and then be connected to the busbar 500 mounted to the second busbar frame 420. The connection method between the electrode leads 111 and 112 and the respective busbar 500 is not particularly limited, but may be a weld junction.

In the same way as above, the battery cells 110 constituting the battery cell stack 120 may be connected in series or parallel to each other.

Meanwhile, although not specifically illustrated, a terminal busbar for external power connection of the battery module 100 or a module connector for transmitting voltage and temperature sensing information may be mounted on the first busbar frame 410 or the second busbar frame 420.

The first side plate 210 and the second side plate 220 according to the present embodiment may be disposed to cover up to the side surface of the first bus bar frame 410 and the side surface of the second busbar frame 420. In this configuration, the lifting holes 200H may be formed in a portion corresponding to the first busbar frame 410 or a portion corresponding to the second busbar frame 420 in the first side plate 210 or the second side plate 220, respectively.

That is, as shown in FIG. 3, the two lifting holes 200H adjacent to each of both ends of the first side plate 210 may be respectively formed in a portion corresponding to the first busbar frame 410 and a portion corresponding to the second busbar frame 420. In addition, the two lifting holes 200H adjacent to each of both ends of the second side plate 220 may be respectively formed in a portion corresponding to the first busbar frame 410 and a portion corresponding to the second busbar frame 420.

Further, referring to FIG. 7, a chamber portion 400C may be formed in each of the portion of the first busbar frame 410 corresponding to one of the lifting holes 200H and the portion of the second busbar frame 420 corresponding to the other of the lifting holes 200H. FIG. 7 shows only the chamber portion 400C formed in the first busbar frame 410, but similarly, the chamber portion 400C may also be formed in the second busbar frame 420.

The chamber portion 400C may be open on one side. More specifically, the chamber portion 400C may be a portion in which one side is open and the other side is closed, while being recessed into the other side in the opposite direction to the one side. A lifting hole 200H according to the present embodiment may be located on the open side of the chamber portion 400C.

In order to handle the battery module 100, which will be covered later, the transfer member 900 is inserted into the lifting hole 200H according to the present embodiment, wherein the chamber portion 400C according to the present embodiment may protect internal components of the battery module 100 from the transfer member 900.

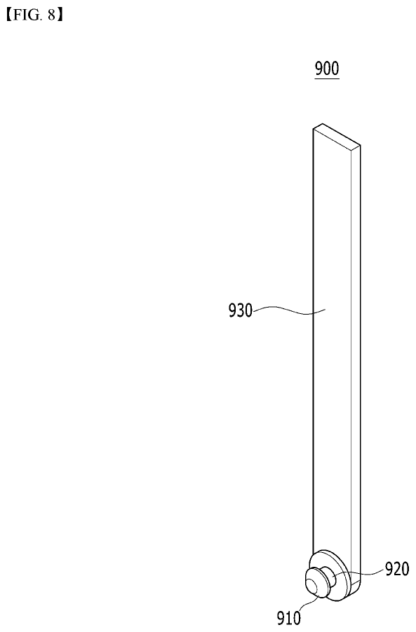

Next, a handling method of the battery module 100 using the lifting hole 200H according to the present embodiment will be described in detail with reference to FIGS. 8 to 11. A handling method of the battery module 100 using the lifting hole 200H according to the present embodiment will be described in detail. Here, the handling method is a concept that collectively refers to transporting or handling the battery module 100, as in a process of moving the battery module 100 or assembling it into a battery pack.

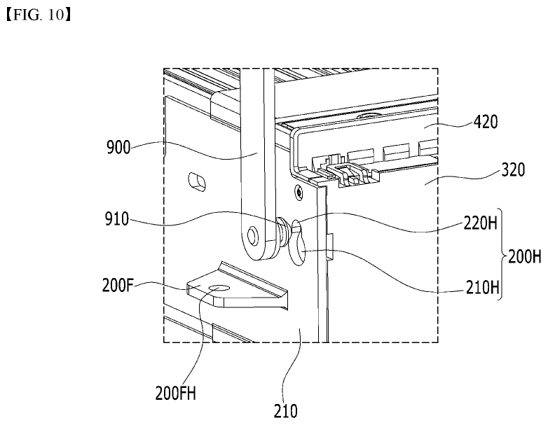

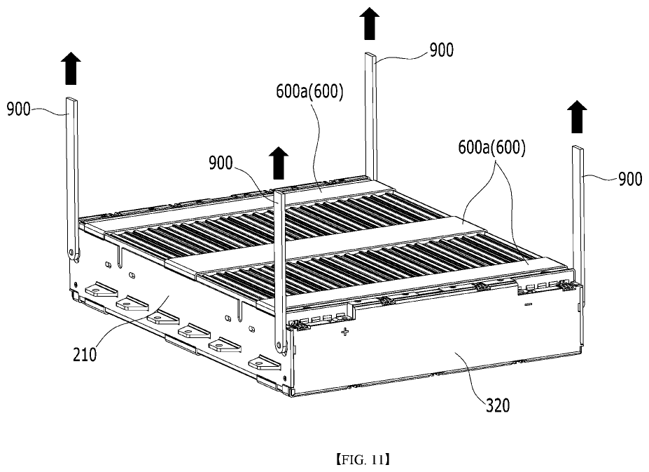

FIG. 8 is a perspective view of a transfer member according to one embodiment of the present disclosure. FIG. 9 is a perspective view of the battery module of FIG. 2 and the transfer member of FIG. 8 together. FIG. 10 is an enlarged partial perspective view of section C of FIG. 9. FIG. 11 is a perspective view of a process of transferring the battery module according to the present embodiment using a transfer member.

Referring to FIGS. 8 to 11 together, the transfer member 900 is inserted into the lifting hole 200H, and the transfer member 900 can lift the battery module 100 through the fastening hole 220H.

Specifically, the transfer member 900 according to the present embodiment may include an insertion portion 910, a fastening portion 920 and a rod portion 930. The insertion portion 910 is a member inserted into the insertion hole 210H of the lifting hole 200H, and may have a shape corresponding to the opening shape of the insertion hole 210H. The fastening portion 920 is a member that can be coupled to the fastening hole 220H of the lifting hole 200H, which may connect the insertion portion 910 and the rod portion 930 and have a shape corresponding to the open shape of the fastening hole 220H. FIG. 8 shows an insertion portion 910 and a fastening portion 920 having a circular shape so that they can be inserted into the insertion hole 210H and the fastening hole 220H which have an open circular shape. The opening area of the fastening hole 220H is smaller than that of the insertion hole 210H, and the fastening portion 920 has a smaller radius than the insertion portion 910 in conformity therewith. Meanwhile, the radius of the insertion portion 910 may be smaller than the radius of the insertion hole 210H and may be larger than the radius of the fastening hole 220H. The rod portion 930 may be a rod-shaped member connected with the fastening portion 920.

FIGS. 9 and 10 show a state before the insertion portion 910 and the fastening portion 920 are inserted into the insertion hole 210H. First, the insertion portion 910 and the fastening portion 920 of the transfer member 900 are inserted into the insertion hole 210H of the lifting hole 200H. Then, as shown in FIG. 11, the fastening portion 920 is coupled to the fastening hole 220H as the transfer member 900 is lifted upward, so that the battery module 100 can be transferred. When the transfer member 900 moves upward, the fastening hole 220H is preferably located higher than the insertion hole 210H so that the fastening portion 920 is naturally coupled to the fastening hole 220H.

Further, as described above, the fastening portion 920 comes into contact with the fastening hole 220H because the radius of the insertion portion 910 is smaller than the radius of the insertion hole 210H and may be larger than the radius of the fastening hole 220H, and then the insertion portion 910 may function as a hooking structure. That is, the insertion portion 910 can prevent the transfer member 900 from deviating to the outside through the fastening hole 220H during the handling process of the battery module 100.

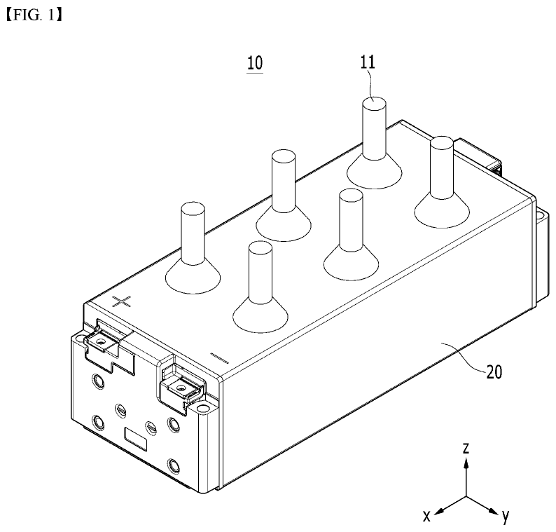

Unlike the handling method using the housing in the conventional battery module 10 shown in FIG. 1, the housing structure is omitted in the battery module 100 according to the present embodiment, and the lifting holes 200H for handling are provided in the first side plate 210 and the second side plate 220 in conformity therewith. That is, the lifting hole 200H and the transfer member 900 according to the present embodiment may implement a handling method that can be optimally applied to the battery module 100 of the present embodiment in which the housing is simplified. In addition, the handling process can be simplified and the costs can be reduced because the battery module 100 can be lifted only by the transfer member 900 without a lot of space or parts.

Meanwhile, as described above, at this time, the lifting holes 200H may be formed in a portion corresponding to the first busbar frame 410 or a portion corresponding to the second busbar frame 420 in the first side plate 210 or the second side plate 220, respectively. Accordingly, the chamber portion 400C may be provided in the first busbar frame 410 and the second busbar frame 420, and the internal components of the battery module 100 can be protected from the transfer member 900 during the handling process.

Further, when the lifting holes 200H are disposed in a portion corresponding to the first busbar frame 410 and a portion corresponding to the second busbar frame 420, they are located at four corners in the battery module 100, so that the battery module 100 can be stably lifted.

Next, the connecting member applied to the battery module according to the present embodiment will be described in detail.

Referring to FIGS. 2 and 3 again, the battery module 100 may include the connecting member 600 that connects the first side plate 210 and the second side plate 220, as described above.

At this time, the connecting member 600 according to the present embodiment may be a band member 600a connected with the first side plate 210 and the second side plate 220. The band member 600a may include an elastic metal material, and a single band member 600a or a plurality of band members 600a may be provided. When a plurality of band members 600a are present, they may be located apart from each other at regular intervals. In FIGS. 2 and 3, the state in which three band members 600a are disposed at each of the upper side and the lower side of the battery cell stack 120 is shown as an example.

Such a band member 600a may include a band body 610a and a band clip 620a. The band body 610a is made of a material having elasticity with a predetermined length, and may be disposed on at least one of the upper side or the lower side of the battery cell stack 120.

The band clip 620a is integrally formed with the band body 610a, and may be bent at both ends of the band body 610a and fixed to the first side plate 210 or the second side plate 220. The band clip 620a may be fixed to the first side plate 210 or the second side plate 220 by a method such as a weld junction.

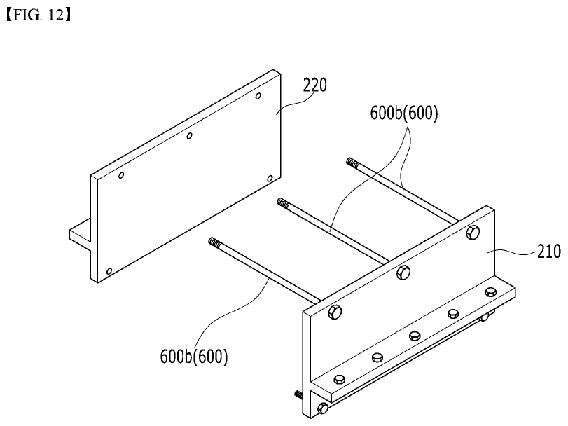

FIG. 12 is a perspective view of a side plate and a connecting member according to another embodiment of the present disclosure. For convenience of explanation, other components are omitted, and only the first side plate 210, the second side plate 220, and the connecting member 600 are illustrated.

Referring to FIG. 12, in another embodiment of the present disclosure, the connecting member 600 may include a long bolt member 600b that is fastened with the first side plate 210 and the second side plate 220. At least one or a plurality of long bolt members 600b may be provided.

The long bolt member 600b is fastened through the first side plate 210 and the second side plate 220 to fix the first side plate 210 and the second side plate 220. This long bolt member 600b may be disposed on at least one of the upper side or the lower side of the battery cell stack 120.

Next, the support portion and the fixing portion of the first side plate and the second side plate according to the present embodiment will be described in detail.

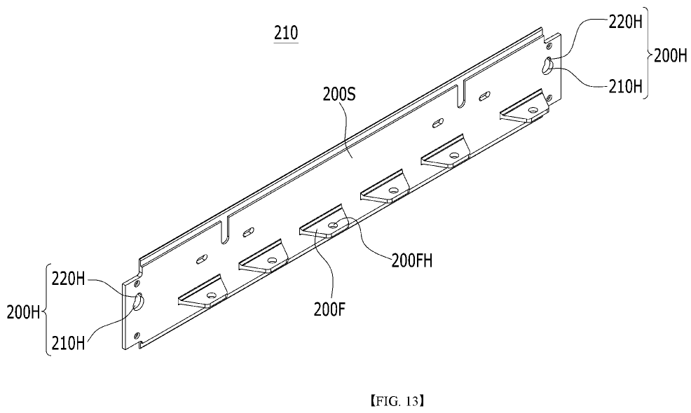

FIG. 13 is a perspective view of a first side plate according to one embodiment of the present disclosure. Since the second side plate may have the same or similar structure as the first side plate, the first side plate will be mainly described below.

Referring to FIGS. 2, 3 and 13, the first side plate 210 and the second side plate 220 according to the present embodiment may include a support portion 200S that supports the outermost battery cell of the battery cell stack, and a fixing portion 200F that protrudes in a direction perpendicular to one surface of the support portion 200S.

The above-mentioned lifting hole 200H may be formed in the support portion 200S of the first side plate 210 and the second side plate 220. A through hole 200FH for mounting and fixing may be formed in the fixing portion 200F. The number of fixing portions 200F is not particularly limited, and a single or a plurality of fixing portions 200F may be provided. In FIG. 13, a state in which a plurality of fixing portions 200F are disposed at predetermined intervals is illustrated.

Next, a configuration of a battery pack according to one embodiment of the present disclosure and a mounting fixing method using the fixing portions of the first side plate and the second side plate described above will be described in detail.

FIG. 14 is a perspective view of a battery pack according to one embodiment of the present disclosure. FIG. 15 is a partial perspective view of a method of fixing a battery module to a pack tray in the battery pack according to the present embodiment.

Referring to FIGS. 13 to 15 together, a battery pack 1000 according to one embodiment of the present disclosure includes a battery module 100 and a pack tray 1100 for housing the battery module.

The pack tray 1100 is a structure having an internal space, and one or more battery modules 100 may be housed therein. One or more battery modules 100 are disposed on the bottom portion 1100F of the pack tray 1100. Although not specifically illustrated, a cover for covering the open upper portion of the pack tray 1100 may be disposed.

It is necessary to mount and fix the battery module 100 to the pack tray 1100 in case of external vibration or impact. The first side plate 210 and the second side plate 220 of the battery module 100 according to the present embodiment are fixed to the pack tray 1100.

Specifically, as described above, the first side plate 210 and the second side plate 220 may include a support portion 200S that supports the outermost battery cells of the battery cell stack and is disposed perpendicular to the bottom portion 1100F of the pack tray 1100, and a fixing portion 200F that protrudes in a direction perpendicular to one surface of the support portion 200S. At this time, the fixing portion 200F may be fixed to the pack tray 1100.

More specifically, the battery pack 1000 according to the present embodiment may further include a mounting beam 1200 that is disposed on an upper surface of the bottom portion 1100F of the pack tray 1100, and the fixing portion 200F may be fixed to the mounting beam 1200.

The mounting beam 1200 has a shape extending along one direction from the upper surface of the bottom portion 1100F of the pack tray 1100. Although not specifically illustrated, a mounting beam 1200 may be located between the battery modules 100 when a plurality of battery modules 100 are disposed. The mounting beam 1200 may fix the battery module 100 and buffer impacts transmitted to the battery module 100 from external impacts.

As shown in FIG. 15, a through hole 200FH for mounting and fixing may be formed in the fixing portion 200F. Meanwhile, the fixing portion 200F may be located higher than the height of the mounting beam 1200 in the height direction. Here, the height direction means a direction perpendicular to one surface of the bottom portion 1100F of the pack tray 1100.

The fixing portion 200F may be fixed to the upper surface of the mounting beam 1200, and a bolt engagement can be performed as shown in FIG. 15. That is, a mounting hole 1200H having a screw thread formed therein may be formed on the upper surface of the mounting beam 1200. The bolt-shaped fastening member 1300 passes through the through hole 200FH of the fixing portion 200F and then can be inserted and fastened into the mounting hole 1200H.

As described above, the battery module 100 according to the present embodiment can be fixed to the pack tray 1100 through the first side plate 210 and the second side plate 220 to configure a battery pack 1000.

Meanwhile, the battery cells 110 may cause a phenomenon in which the internal electrolyte decomposes to generate gas and the battery cell 110 swells in the process of repeating charging and discharging, that is, a swelling phenomenon. If the swelling of the battery cell 110 cannot be controlled, it may cause a structural deformation of the battery module 100 in which the plurality of battery cells 110 are stacked, and may adversely affect the durability and performance of the battery module 100.

Particularly, in recent years, Pure Si cells, all-solid-state batteries, and SiO high-content cells have been used as battery cells to manufacture high-capacity battery modules and battery packs, but the degree of swelling is greater in the case of such cells. That is, it is essential to effectively control swelling of the battery cells 110 inside the battery modules or the battery packs to manufacture high-capacity battery modules and battery packs. Referring to FIG. 3 again, structures directly related to the swelling control are the first side plate 210 and the second side plate 220 disposed on both side surfaces of the battery cell stack 120 because the pouch-type battery cells 110 usually have a large degree of swelling in the thickness direction.

The battery module 100 according to the present embodiment has a simplified housing structure through the first side plate 210 and the second side plate 220 and the connecting member 600 connecting them, rather than a housing having a shape that integrally surrounds the battery cell stack. It may be difficult to have lateral stiffness and durability sufficient to control swelling of the battery cells 110 with such a structure because it is not the shape of the conventional housing shown in FIG. 1.

Therefore, the battery pack 1000 according to the present embodiment has been designed to be the battery module 100 having a simplified housing structure, while the first side plate 210 and the second side plate 220 are directly coupled and fixed to the mounting beam 1200 on the pack tray 1100, where the mounting beam 1200 supports the first side plate 210 or the second side plate 220 from the side and controls swelling.

That is, mounting fixation is performed through the first side plate 210 and the second side plate 220, and at the same time, the mounting beam 1200 can supplement the stiffness and durability of the battery module 100 for swelling control.

Taken together, the first side plate 210 and the second side plate 220 according to the present embodiment can be formed with a lifting hole 200H in the battery module 100 having a simplified housing structure to function as a handling structure, can be directly fixed to the mounting beam 1200 on the pack tray 1100 to perform the function of mounting fixation, and can also perform a function of supplementing the stiffness for swelling control of the battery module 100.

Meanwhile, referring to FIG. 3 again, a compression pad 700 may be located between one side of the battery cell stack 120 and the first side plate 210 and between the other side of the battery cell stack 120 and the second side plate 220. The compression pad 700 is a member in the form of a foam, and may be disposed for the purpose of absorbing swelling and heat insulation of the battery cells 110.

In addition, the battery module 100 according to the present embodiment further includes an insulating sheet 800 located between the battery cell stack 120 and the connecting members 600 located on the upper side of the battery cell stack 120. The insulating sheet 800 is an electrically insulating thin sheet, and may be disposed to cover the entire upper surface of the battery cell stack 120 in order to ensure electrical insulation of the upper side of the battery cell stack 120. The insulating sheet 800 may be an insulating film or an insulating tape, and may have a thickness of 0.1 mm or less.

In another embodiment of the present disclosure, an insulating sheet cannot also be disposed between the battery cell stack 120 and the connecting members 600. That is, an embodiment in which the upper surface of the battery cell stack 120 is exposed to the outside in between the connecting members 600 is also possible.

Meanwhile, although not specifically illustrated, the battery pack according to the present embodiment may further include not only battery modules but also various control and protection systems such as a BMS (battery management system), a BDU (battery disconnect unit), and a cooling system.

The above-mentioned battery module or battery pack according to the present embodiment can be applied to various devices. Specifically, such a device can be applied to a vehicle means such as an electric bicycle, an electric vehicle, or a hybrid vehicle, or an ESS (Energy Storage System), but the present disclosure is not limited thereto, and is applicable to various devices that can use a secondary battery.

The terms representing directions such as the front side, the rear side, the left side, the right side, the upper side, and the lower side have been used in embodiments of the present disclosure, but it is obvious to those skilled in the art that the terms used are provided simply for convenience of description and may become different according to the position of an object, the position of an observer, or the like.

Although preferred embodiments of the present disclosure have been described in detail above, the scope of the present disclosure is not limited thereto, and various modifications and improvements can be made by those skilled in the art using the basic concepts of the present disclosure which are defined in the appended claims, which also fall within the scope of the present disclosure.

1. A battery module comprising:
a battery cell stack comprising a plurality of battery cells; and
a first side plate and a second side plate each located at first and second side surfaces of the battery cell stack,
wherein the first side surface is opposite to the second side surface,
wherein at least one lifting hole is formed in each of the first side plate and the second side plate,
wherein the at least one lifting hole has a shape in which an insertion hole and a fastening hole overlap, and
wherein an opening area of the insertion hole is larger than an opening area of the fastening hole.

2. The battery module according to claim 1, wherein:
the fastening hole is located higher than the insertion hole, and
the opening area of the insertion hole and the opening area of the fastening hole are connected to each other.

3. The battery module according to claim 1, wherein:
a shape of the opening area of the insertion hole and the opening are of the fastening hole is a circle or a polygon.

4. The battery module according to claim 1, further comprising:
a first end plate and a second end plate located on a first side and a second side of the battery cell stack, respectively, wherein the first side is opposite to the second side of the battery cell stack;
a first busbar frame located between the battery cell stack and the first end plate; and
a second busbar frame located between the battery cell stack and the second end plate,
wherein the at least one lifting hole is formed in the first side plate in a portion corresponding to the first busbar frame or formed in the second side plate in a portion corresponding to the second busbar frame.

5. The battery module according to claim 4, wherein:
each of the first side plate and the second side plate comprises at least two lifting holes, and
a first chamber portion is formed in a first busbar frame portion corresponding to a first of the at least two lifting holes and a second chamber portion is formed in a second busbar frame portion corresponding to a second of the at least two lifting holes.

6. The battery module according to claim 5, wherein:
each of the first and second chamber portions comprises an open first side, and
each of the at least two lifting hole is located at a corresponding open first side of the first and second chamber portions, respectively.

7. The battery module according to claim 4, further comprising:
busbars mounted on the first busbar frame and the second busbar frame,
wherein electrode leads of the plurality of battery cells pass through lead slits formed in the first busbar frame or the second busbar frame, and
wherein the electrode leads are bent and connected to the busbar after passing through the lead slits.

8. The battery module according to claim 1, wherein:
a transfer member is inserted into the insertion hole, and
the transfer member lifts the battery module through the fastening hole.

9. The battery module according to claim 1, further comprising:
a plurality of connecting members that are located at each of the upper and lower sides of the battery cell stack,
wherein the plurality of connecting members connect the first side plate and the second side plate.

10. The battery module according to claim 9, wherein:
the plurality of connecting members are band members that are connected to the first side plate and the second side plate.

11. The battery module according to claim 10, wherein:
each of the band members comprises a band body disposed on the upper side or the lower side of the battery cell stack, and band clips bent from the band body and fixed to each of the first side plate and the second side plate.

12. The battery module according to claim 9, wherein:
the plurality of connecting members comprise long bolt members that are fastened to the first side plate and the second side plate.

13. The battery module according to claim 9, wherein:
the plurality of connecting members are disposed apart from each other on the upper side or the lower side of the battery cell stack.

14. A battery pack comprising:
the battery module as set forth in claim 1; and
a pack tray that houses the battery module,
wherein the first side plate and the second side plate of the battery module are fixed to the pack tray.

15. The battery pack according to claim 14, wherein:
the first side plate and the second side plate each comprises a support portion that is disposed perpendicular to a bottom portion of the pack tray and supports an outermost battery cell of the battery cell stack, and a fixing portion that protrudes in a direction perpendicular to a surface of the support portion, and
the fixing portion is fixed to the pack tray.

16. The battery pack according to claim 15, further comprising:
a mounting beam disposed on an upper surface of the bottom portion of the pack tray,
wherein the fixing portion is fixed to the mounting beam.

17. The battery pack according to claim 16, wherein:
the fixing portion is located higher than a height of the mounting beam in a height direction, and the height direction is a direction perpendicular to a surface of the bottom portion of the pack tray.
